(19) United States
(12) Patent Application Publication
(10) Pub. No.: US 2026/0295722 A1
(43) Pub. Date: Oct. 1, 2026

(54) LASER DEVICE AND METHOD FOR PROCESSING AT LEAST ONE WORKPIECE BY MEANS OF AT LEAST ONE LASER BEAM

(71) Applicant: TRUMPF LASER- UND SYSTEMTECHNIK SE, Ditzingen (DE)

(72) Inventors: Oliver BOCKSROCKER, Sachsenheim (DE); Patrick HAUG, Unteriflingen (DE); Nicolai SPEKER, Pleidelsheim (DE); Tim HESSE, Ditzingen (DE)

(21) Appl. No.: 19/688,585

(22) Filed: May 27, 2026

Related U.S. Application Data
(63) Continuation of application No. PCT/EP2024/083713, filed on Nov. 27, 2024.

(30) Foreign Application Priority Data
Dec. 6, 2023 (DE) 10 2023 134 096.4

(51) Int. Cl. B23K 26/073; B23K 26/03; B23K 26/06; B23K 26/064; B23K 26/082

(52) U.S. Cl. CPC B23K 26/0734; B23K 26/032; B23K 26/064; B23K 26/0665; B23K 26/082

(57) ABSTRACT

A laser device for processing a workpiece is configured to generate and focus at least one laser beam onto the workpiece so that a laser spot is generated on the workpiece. The laser spot has a core region and a ring region. An average laser power density in the core region is higher than an average laser power density in the ring region. The laser device is configured to vary the average laser power density in the core region with a first variation frequency of at least 50 kHz and a first variation amplitude of at least 10% of the average laser power density in the core region, and/or vary the average power density in the ring region with a second variation frequency of at least 50 kHz and a second variation amplitude of at least 10% of the average laser power density in the ring region.

### CROSS REFERENCE TO RELATED APPLICATIONS

This application is a continuation of International Application No. PCT/EP 2024/083713 (WO 2025/119721A1 ), filed on Nov. 27, 2024, and claims benefit to German Patent Application No. DE 10 2023 134 096.4, filed on Dec. 6, 2023. The aforementioned applications are hereby incorporated by reference herein.

### FIELD

Embodiments of the present invention relate to a laser device for processing at least one workpiece by means of at least one laser beam and a method for processing at least one workpiece by means of at least one laser beam.

### BACKGROUND

When laser welding at least two components, CW (continuous wave) lasers with a constant power over the duration of the laser welding process are typically used for deep welding. Particularly when deep welding metallic materials with a low viscosity, instabilities may occur in the weld region, in particular in the so-called keyhole. This can result in spatter, pores, and/or an uneven weld penetration depth, for example. In order to reduce such instabilities, multiple laser beams can be superimposed. However, this does not eliminate all instabilities, in particular in metallic materials with low viscosity.

### SUMMARY

Embodiments of the present invention provide a laser device for processing a workpiece by using at least one laser beam. The laser device is configured to generate the at least one laser beam, and focus the at least one laser beam onto the workpiece so that the at least one laser beam generates a laser spot on the workpiece. The laser spot has a core region and a ring region. An average laser power density in the core region is higher than an average laser power density in the ring region. The laser device is further configured to vary the average laser power density in the core region with a first variation frequency of at least 50 kHz and a first variation amplitude of at least 10% of the average laser power density in the core region, and/or vary the average power density in the ring region with a second variation frequency of at least 50 kHz and a second variation amplitude of at least 10% of the average laser power density in the ring region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a laser device for processing at least one workpiece according to some embodiments;

FIG. 2 shows a schematic top view of the workpiece and a laser spot of a laser beam from the laser device according to FIG. 1, according to some embodiments;

FIG. 3 shows a schematic cross-section of a fiber of the laser device according to FIG. 1, according to some embodiments; and

FIG. 4 shows a schematic diagram of the progression of average laser power densities in the core region and ring region of the laser spot of the laser beam of the laser device according to FIG. 1, according to some embodiments.

### DETAILED DESCRIPTION

Embodiments of the present invention provide a laser device and a method for processing, in particular laser welding, at least one workpiece by means of at least one laser beam, wherein the above-mentioned disadvantages are rectified.

The laser device is configured to generate the laser beam and focus it onto the workpiece in such a manner that the laser beam creates a laser spot on the workpiece. The laser spot has an, in particular circular, core region and an, in particular annular, ring region. An average laser power density in the core region is higher than an average laser power density in the ring region.

The laser device is also designed to vary the average laser power density in the core region with a variation frequency of at least 50 kHz (kilohertz) and a variation amplitude of at least 10% of the average laser power density of the core region. Alternatively or in addition, the laser device is configured to vary the average laser power density in the ring region with a variation frequency of at least 50 kHz and a variation amplitude of at least 10% of the average laser power density of the ring region. The average laser power density in the ring region may correspond to a maximum of 5% of the (total) laser power.

In this context, the variation amplitude may be either positive or negative. In other words, the average laser power density (of the core and/or ring region) may be periodically increased in each case (with a positive variation amplitude) and/or reduced (with a negative variation amplitude).

This can achieve (additional) stabilization of the keyhole, in particular in workpieces with a lower viscosity, thereby reducing spatter and pores and achieving the most continuous possible weld penetration depth. Keyhole instabilities can be avoided or at least reduced, in particular, by increasing and decreasing the vapor rate and vapor pressure quickly enough to prevent the keyhole from collapsing. In other words, the keyhole may be stabilized by selectively influencing the vapor pressure (or vapor rate), which can lead to fewer spatters, fewer pores, and a constant weld penetration depth.

According to a further development of the laser device, the laser device may be configured to keep the average laser power density in the core region and/or the average laser power density in the ring region constant. With a plurality of laser beams or a plurality of laser spots, the average laser power density of at least one of the core regions and/or the average laser power density of at least one of the ring regions can be kept constant. Alternatively or in addition, the average laser power density in the core region and/or the average laser power density in the ring region may be varied with the variation frequency. With a plurality of laser beams or a plurality of laser spots, the average laser power density of at least one of the core regions and/or the average laser power density of at least one of the ring regions can be varied with the variation frequency.

According to a further development of the laser device, the laser device may be configured to vary the average laser power density in the core region and the average laser power density in the ring region, in each case with a different variation frequency and/or a different variation amplitude. It is also conceivable that the average laser power densities in the core region and in the ring region can, in each case, be varied with the same variation frequency and/or variation amplitude.

This allows the laser spot to be selectively adjusted and optimized in specific regions, enabling further stabilization of the keyhole.

According to a further development of the laser device, the laser device for generating the laser beam, in particular the core region and/or the ring region, may comprise at least one CW laser. In this regard, the laser device may be configured such that the core region and/or the ring region of the laser spot are, in each case, modulated with a modulation frequency and a modulation amplitude. In this context, the modulation frequency can correspond to the variation frequency, and the modulation amplitude can correspond to the variation amplitude. The CW laser may have an average power output of at least 0.2 kW (kilowatts), preferably at least 4 kW.

This allows the laser beam, in particular the core region and/or the ring region, to be generated using simple means.

It is also conceivable that the laser device for generating the laser beam, in particular the core region and/or the ring region, may comprise at least one pulsed laser. In this regard, the pulse repetition rate of the pulsed laser may correspond to the variation frequency. The pulsed laser may have an average power of at least 0.2 kW, preferably at least 4 kW, and/or a pulse energy of at least 10 mJ (millijoules), preferably at least 50 mJ.

It is conceivable that the core region of the laser spot is generated using a pulsed laser (in particular an ns (nanosecond) pulsed laser) and the ring region of the laser spot is generated using a CW laser or vice versa.

The pulsed laser and/or the CW laser can each produce a maximum beam parameter product of 8 mm*mrad (millimeters*milliradians). The pulsed laser and/or the CW laser can each be designed as a (multi-mode) NIR (near-infrared) laser. It is also conceivable that the pulsed laser and/or the CW laser may each be designed as a laser in the visible range (VIS laser) with a wavelength in a blue or green wavelength range. The pulsed laser and/or the CW laser can each be designed as a solid-state laser.

The laser device may comprise a control device. The control device may be configured to program and/or control the (high-frequency) modulation or pulsation with the variation frequency and variation amplitude. The control device may be configured to control the core region and ring region of the laser spot generated by the light beam, in particular separately and independently of one another, or to modulate or adjust the respective average laser power density.

The laser device may have a nozzle for supplying a shielding gas (cutting or welding gas) to the workpiece. This may have a Laval internal geometry.

According to a further development of the laser device, the laser device may comprise at least two, in particular different, laser sources for generating the laser beam, in particular the core region and/or the ring region. For example, the core region can be generated using at least one first laser and the ring region can be generated using at least one second laser.

This allows the laser spot to be selectively generated and adjusted in specific regions, enabling further stabilization of the keyhole.

According to a further development of the laser device, the laser device for generating the laser beam and/or the laser spot may comprise a fiber (2-in-1 fiber) with a core region and a ring region. The core region of the fiber may have an outer diameter of at most 30 μm (micrometers), in particular at most 20 μm, preferably at most 10 μm (e.g., in basic mode or single mode). Alternatively, the core region of the fiber may have a larger outer diameter, in particular at least 50 μm or 100 μm (e.g., in multi mode). Alternatively or in addition, the ring region may have an outer diameter of 200 μm or 400 μm. The core region may be arranged within the ring region. The ratio between the outer diameter of the core region and the outer diameter of the ring region may be in the range from 1:2 to 1:9, in particular 1:3, 1:4, or 1:6.

The core region may have a cladding. The cladding may be arranged between the core region and the ring region. The cladding may have a maximum thickness of 10 μm. The cladding may have a lower refractive index compared to the core region and/or ring region. The fiber may be configured in such a way that, due to the cladding of the core region, the light within the core region is “enclosed”, in particular due to total internal reflection at the boundary between the core region and the cladding. Accordingly, the light in the ring region, which can be totally reflected between the cladding of the core region and an additional cladding of the ring region, can be “enclosed”.

This allows the welding region, in particular the keyhole, to be further stabilized. This can lead to a further reduction in instability (within the keyhole) and to fewer spatters and fewer pores, as well as a constant weld penetration depth. Due to the cladding of the core region and/or the ring region, light in the core region and ring region can be guided in a manner isolated from one another.

According to a further development of the laser device, the laser device may be configured in such a way that at least two laser beams are generated and focused onto the workpiece. In particular, at least four laser beams may be generated and focused onto the workpiece. In particular, all laser beams may, in each case, be designed to be identical. Accordingly, all laser spots generated onto the workpiece by the respective laser beams may, in each case, be designed to be identical. In order to generate a plurality of laser beams, the laser device may comprise an optical element for beam splitting, in particular a wedge switch.

This allows the welding region, in particular the keyhole, to be further stabilized. This can lead to a further reduction in instability (within the keyhole) and to fewer spatters and fewer pores, as well as a constant weld penetration depth.

According to a further development of the laser device, the laser device may be configured in such a way that the rise time and/or fall time of the variation amplitude corresponds to a maximum of 10 μs (microseconds).

In this context, rise time refers to the time required to increase the average laser power density to a maximum value (e.g., the positive variation amplitude). Correspondingly, fall time refers to the time required to reduce the average laser power density to a minimum value (e.g., the negative variation amplitude).

According to a further development of the laser device, the laser device may comprise a scanner optical unit for moving the laser beam over the workpiece. The scanner optical unit may have an aspect ratio in a range from 1:1 to 5:1, preferably 1.9:1 or 3.4:1.

This allows the laser beam to be optimally focused onto the workpiece and/or moved across the workpiece using simple means.

According to a further development of the laser device, the laser device may comprise an optical sensor for position detection of the laser beam and/or the workpiece. The optical sensor can be designed as a camera-based sensor or as a camera. It is also conceivable that the optical sensor may be designed as an interferometer-based sensor system. The laser beam and the optical sensor may be calibrated on one another.

This allows for position control of the laser beam and/or the workpiece using simple means. This allows the processing, in particular laser welding, of the workpiece to be carried out as precisely as possible.

Embodiments of the present invention also provide a method for processing at least one workpiece by means of at least one laser beam. The processing may involve laser welding.

The method comprises the steps of:
providing the workpiece. The workpiece may be made of metal, in particular aluminum and/or copper. The workpiece may have a maximum viscosity of 5 mPa*s (millipascals*second) in the molten state (at melting temperature). The workpiece may have a maximum thickness of 4 mm (millimeters).
generating and focusing at least one laser beam onto the workpiece in such a manner that the laser beam generates a laser spot on the workpiece, wherein the laser spot has an, in particular circular, core region and an, in particular annular, ring region. In this context, the average laser power density in the core region is higher than the average laser power density in the ring region. varying, in particular pulsing or modulating, the average laser power density in the core region and/or the average laser power density in the ring region, in each case with a variation frequency of at least 50 kHz and a variation amplitude of at least 10% of the respective average laser power density. In this context, the rise and/or fall time of the variation amplitude may be less than 10 μs (microseconds). The variation amplitude may be either positive or negative. In other words, the average laser power density may be periodically increased (with a positive variation amplitude) and/or reduced (with a negative variation amplitude).

This can achieve (additional) stabilization of the keyhole, in particular in workpieces with a lower viscosity, thereby reducing spatter and pores and achieving the most continuous possible weld penetration depth. Keyhole instabilities can be avoided or at least reduced, in particular, by increasing and decreasing the vapor rate and vapor pressure quickly enough to prevent the keyhole from collapsing. In other words, the keyhole may be stabilized by selectively influencing the vapor pressure (or vapor rate), which can lead to fewer spatters, fewer pores, and a constant weld penetration depth.

The method may comprise the step of:
supplying a shielding gas (cutting or welding gas) to the workpiece, in particular in the region where the workpiece is being processed. This can be achieved using a nozzle, in particular one with a Laval internal geometry.

According to a further development of the method, the method may comprise the step of:
moving the laser beam and/or the workpiece to advance the laser beam focused onto the workpiece. In this regard, the laser beam can be moved across the workpiece using a scanner optical unit. The movement of the laser beam and/or the workpiece may be a relative movement between the laser beam and the workpiece. In other words, either the laser beam or the workpiece, or both, may be moved.

This allows for continuous processing of the workpiece, e.g., a weld seam, to be implemented with simple means.

According to a further development of the method, the method may comprise the step of:
determining a position of the laser beam and/or the workpiece. This can be implemented by means of an optical sensor.
possibly readjusting a processing position of the laser beam and/or the workpiece.

This allows for simple position control and, in case of deviation, for a corresponding adjustment of the laser beam and/or the workpiece.

According to a further development of the method, the method may comprise the step of:
varying, in particular pulsing or modulating, the average laser power density in the core region and the average laser power density in the ring region, in each case with a different variation frequency and/or a different variation amplitude of the respective average laser power density.

This allows the respective energy input through the core region or the ring region to be adjusted and optimized in a targeted manner and as desired.

According to a further development of the method, a laser device according to the above-mentioned embodiments can be used to carry out the method.

With regard to the advantages that can be achieved, reference is made to the relevant embodiments relating to the laser device. The measures described in connection with the laser device and/or those explained below may be used to further develop the method.

In the following description and in the figures, corresponding components and elements have the same reference signs. For the sake of better clarity, all reference signs are not reproduced in all of the figures.

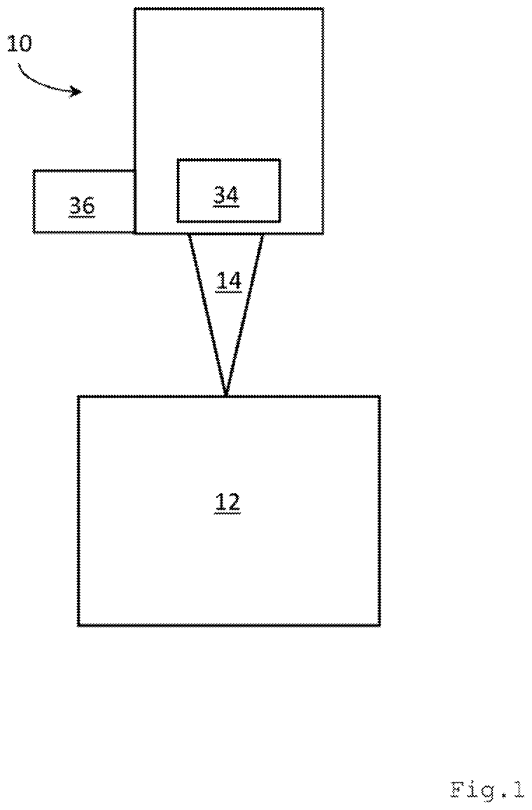

FIG. 1 schematically shows a laser device 10 for processing at least one workpiece 12 by means of at least one laser beam 14. In the present case, the type of processing is laser welding.

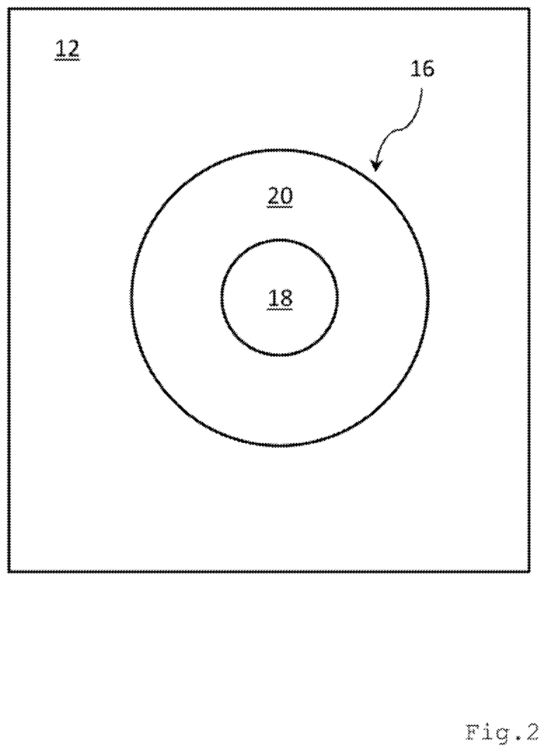

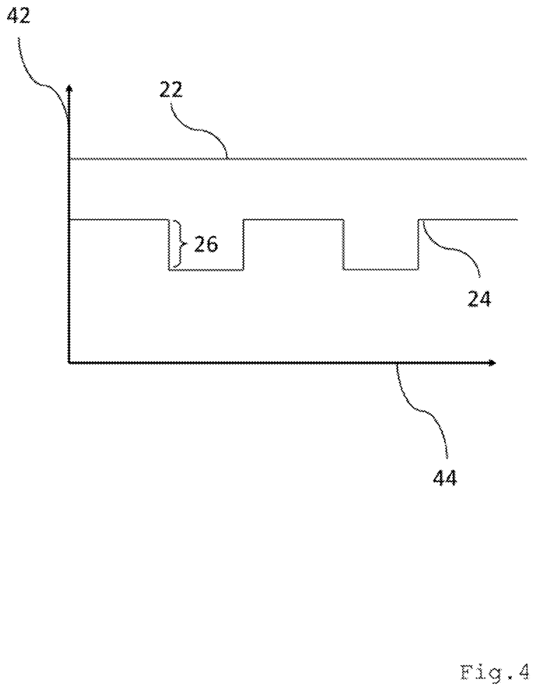

The laser device 10 is configured to generate the laser beam 14 and to focus it onto the workpiece 12 in such a manner that the laser beam 14 generates a laser spot 16 on the workpiece 12, wherein the laser spot 16 has an, in particular circular, core region 18 and an, in particular annular, ring region 20 (see FIG. 2). An average laser power density 22 in the core region 18 is higher than an average laser power density 24 in the ring region 20 (see FIG. 4).

The laser device 10 is also configured to vary the average laser power density 22 in the core region 18 and/or the average laser power density 24 in the ring region 20, in each case with a variation frequency of at least 50 kHz and a variation amplitude 26 of at least 10% of the respective average laser power density 22, 24 (see FIG. 4).

The laser device 10 may be configured such that the rise time and/or fall time of the variation amplitude 26 corresponds to a maximum of 10 μs.

The laser device 10 may be configured to vary the average laser power density 22 in the core region 18 and the average laser power density 24 in the ring region 20, in each case with a different variation frequency and/or a different variation amplitude 26.

The laser device 10 may comprise a CW laser for generating the laser beam 14, in particular the core region 18 and/or the ring region 20. The laser device 10 may be configured such that the core region 18 and/or the ring region 20 of the laser spot 16 is modulated with a modulation frequency and a modulation amplitude. In this context, the modulation frequency can correspond to the variation frequency and the modulation amplitude can correspond to the variation amplitude 26. The CW laser may have an average power output of at least 1 kW, in particular at least 4 kW.

In the present case, the laser device 10 comprises a scanner optical unit 34 for moving the laser beam 14 over the workpiece 12. The scanner optical unit 34 may have an aspect ratio in a range from 1:1 to 5:1, preferably 1.9:1 or 3.4:1.

In the present case, the laser device 10 also comprises an optical sensor 36 for position detection of the laser beam 14 and/or the workpiece 12.

The laser device 10 may be configured such that at least two, in particular at least four, laser beams 14 are generated and focused onto the workpiece 12. In this context, all laser beams 14 (or the laser spots 16 generated by the respective laser beams 14) may, in each case, be designed to be identical.

FIG. 2 shows a schematic top view of the workpiece 12 and a laser spot 16 of the laser beam 14 of the laser device 10 according to FIG. 1.

In the present case, the laser device 10 comprises a fiber 28 with a core region 30 and a ring region 32 for generating the laser beam 14 and/or the laser spot 16.

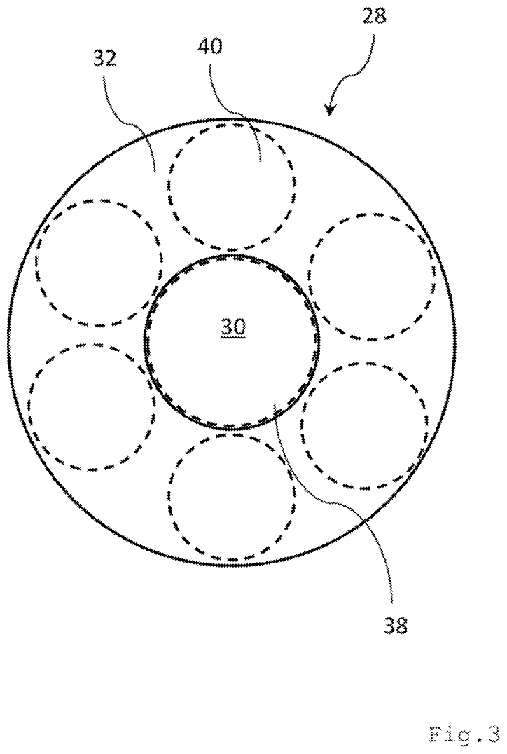

FIG. 3 shows a schematic cross-section of the fiber 28 of the laser device 10 according to FIG. 1.

In the present case, the core region 30 of the fiber 28 is arranged within the ring region 32 of the fiber 28. The core region 30 of the fiber 28 may have an outer diameter of 50 μm or 100 μm. The ring region 32 of the fiber 28 may have an outer diameter of 200 μm or 400 μm.

In the present case, the laser device 10 has at least two laser sources for generating the laser beam 14. The laser sources may be designed in different ways. In the present case, light from a first laser source is coupled into the core region 30 of the fiber 28. For this purpose, the core region 30 of the fiber 28 may be coupled to a first optical fiber 38 (first fiber). The first optical fiber 38 coupled to the core region 30 is indicated in FIG. 3 by means of a dashed circle.

In the present case, light from at least one second laser source is coupled into the ring region 32 of the fiber 28. For this purpose, the ring region 32 of the fiber 28 may be coupled to multiple, in this case six, second optical fibers (second fibers). The second optical fibers 40 coupled to the ring region 32 of the fiber 28 are indicated in FIG. 3 by means of a dashed circle. The six second optical fibers 40 may be supplied with light by means of a common second laser source. It is also conceivable that the six second optical fibers 40 may each be supplied with light by means of a separate second laser source (i.e., a total of six second laser sources).

FIG. 4 shows a schematic diagram of the progression of the average laser power densities 22, 24 in the core region 18 and ring region 20 of the laser spot 16 of the light beam 14 of the laser device 10 according to FIG. 1.

The diagram shown plots the average laser power density 42 of the laser spot 16 of the laser beam 14 of the laser device 10 in W/cm² (watts per square centimeter) over the time 44 in seconds. In other words, the x-axis represents the time 44 in seconds and the y-axis represents the average laser power density 42 in W/cm².

In the present case, the average laser power density 22 of the core region 18 of the laser spot 16 is kept constant. In other words, the average laser power density 22 of the core region 18 of the laser spot 16 is not modulated in the present case. The average laser power density 24 of the ring region 20 is modulated here with the modulation frequency and the modulation amplitude. In other words, the average laser power density 24 of the ring region 20 is periodically varied by at least 10% (modulation amplitude). The average laser power density 24 of the ring region 20 of the laser spot 16 is thus changed by the modulation amplitude or the variation amplitude 26 at regular intervals of a maximum of 20 μs (since the modulation frequency or variation frequency is at least 50 kHz). In the example shown, the average laser power density 24 of the ring region 20 is reduced by the variation amplitude 26 at intervals of a maximum of 20 μs and increased again to the starting value. In the present case, the variation amplitude is greater than 10% and less than 100% of the average laser power density 24 of the ring region 20 of the laser spot 16.

The following describes a method for processing, in particular laser welding, at least one workpiece 12 with reference to FIGS. 1 to 4. The method comprises the steps of: providing the workpiece 12. The workpiece 12 may be made of metal, in particular aluminum and/or copper. The workpiece 12 may have a maximum viscosity of 5 mPa*s in the molten state. generating and focusing at least one laser beam 14 onto the workpiece 12 in such a manner that the laser beam 14 generates a laser spot 16 on the workpiece 12, wherein the laser spot 16 has an, in particular circular, core region 18 and an, in particular annular, ring region 20. An average laser power density 22 in the core region 18 is higher than an average laser power density 24 in the ring region 20. varying, in particular pulsing or modulating, the average laser power density 22 in the core region 18 and/or the average laser power density 24 in the ring region 20, in each case with a variation frequency of at least 50 kHz and a variation amplitude 26 of at least 10% of the respective average laser power density 22, 24. The rise and/or fall time of the variation amplitude 26 may be less than 10 μs.

The method may comprise the step of:
moving the laser beam 14 and/or the workpiece 12 to advance the laser beam 14 or laser spot 16 focused onto the workpiece 12. The movement of the laser beam 14 or the laser spot 16 can be implemented using a scanner optical unit 34.

The method may also comprise the step of:
determining the position of the laser beam 14 and/or the workpiece 12. This may be implemented by means of an optical sensor 36.

The method may comprise the step of:
varying, in particular pulsing or modulating, the average laser power density 22 in the core region 18 and the average laser power density 24 in the ring region 20, in each case with a different variation frequency and/or a different variation amplitude 26 of the respective average laser power density 22, 24.

In order to carry out the method, a laser device 10 according to the above-mentioned embodiments, in particular the laser device 10 shown in FIG. 1, can be used.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser device for processing a workpiece by using at least one laser beam, the laser device being configured to:
generate the at least one laser beam,
focus the at least one laser beam onto the workpiece so that the at least one laser beam generates a laser spot on the workpiece, wherein the laser spot has a core region and a ring region, wherein an average laser power density in the core region is higher than an average laser power density in the ring region, and
vary the average laser power density in the core region with a first variation frequency of at least 50 kHz and a first variation amplitude of at least 10% of the average laser power density in the core region, and/or vary the average power density in the ring region with a second variation frequency of at least 50 kHz and a second variation amplitude of at least 10% of the average laser power density in the ring region.

2. The laser device according to claim 1, wherein the first variation frequency and the second variation frequency are different, and/or the first variation amplitude and the second variation amplitude are different.

3. The laser device according to claim 1, being configured to keep the average laser power density in the core region and/or the average laser power density in the ring region constant.

4. The laser device according to claim 1, comprising at least one continuous-wave (CW) laser, the laser device being configured such that the core region or the ring region of the laser spot is modulated with a modulation frequency and a modulation amplitude, wherein the modulation frequency corresponds to the first variation frequency or the second variation frequency, and the modulation amplitude corresponds to the first variation amplitude or the second variation amplitude, wherein the CW laser has an average power of at least 0.2 kW.

5. The laser device according to claim 1, comprising at least two laser sources for generating the at least one laser beam.

6. The laser device according to claim 1, comprising a fiber with a fiber core region and a fiber ring region.

7. The laser device according to claim 1, wherein at least two laser beams are generated and focused onto the workpiece, wherein the at least two laser beams are configured to be identical.

8. The laser device according to claim 1, being configured such that a first rise time and/or a first fall time of the first variation amplitude is at most 10 μs, and/or a second rise time and/or a second fall time of the second variation amplitude is at most 10 μs.

9. The laser device according to claim 1, comprising a scanner optical unit for moving the at least one laser beam over the workpiece.

10. The laser device according to claim 1, comprising an optical sensor for position detection of the at least one laser beam and/or the workpiece.

11. A method for processing a workpiece by using at least one laser beam, the method comprising:
providing the workpiece;
generating and focusing the at least one laser beam onto the workpiece so that the at least one laser beam generates a laser spot on the workpiece, wherein the laser spot has a core region and a ring region, wherein an average laser power density in the core region is higher than an average laser power density in the ring region;
varying the average laser power density in the core region with a first variation frequency of at least 50 kHz and a first variation amplitude of at least 10% of the average laser power density in the core region, and
varying the average laser power density in the ring region with a second variation frequency of at least 50 kHz and a second variation amplitude of at least 10% of the average laser power density in the ring region.

12. The method according to claim 11, further comprising:
moving the at least one laser beam and/or the workpiece to advance the at least one laser beam focused onto the workpiece using a scanner optical unit.

13. The method according to claim 11, further comprising:
determining a position of the at least one laser beam and/or the workpiece using an optical sensor.

14. The method according to claim 11, wherein the first variation frequency and the second variation frequency are different, and/or the first variation amplitude and the second variation amplitude are different.
